(19) United States
(12) Patent Application Publication
(10) Pub. No.: US 2022/0142058 A1
(43) Pub. Date: May 12, 2022

(54) SPLICED SMALL ARCH SHED FRAME

(71) Applicant: Jinhua Longchu Gardening Tools Co., Ltd, Jinhua City (CN)

(72) Inventor: Botu DING, Hangzhou City (CN)

(21) Appl. No.: 17/523,677

(22) Filed: Nov. 10, 2021

(30) Foreign Application Priority Data
Nov. 11, 2020 (CN) 202022604740.X

(51) Int. Cl. A01G 9/16

(52) U.S. Cl. CPC A01G 9/16

(57) ABSTRACT

The present invention discloses a spliced small arch shed frame, applying to the technical field of agricultural equipment. The arch pole, the transverse connecting pole and the longitudinal connecting pole of the small arch shed are all connected by a number of supporting hoops and a number of double-ended connectors; two transverse connecting poles and two longitudinal connecting poles are connected end to end together to form a rectangular base support structure; a plurality of mutually parallel arch poles are arranged between the two transverse connecting poles; all arch poles are located above the base support structure and together constitute the arch support structure; the fixed pole is set on the top of the arch support structure, and is connected with each arch pole in the arch support structure through two fixed ends of the bi-directional clip, so that all arch poles are connected as a whole

### TECHNICAL FIELD

The present invention applies to the technical field of agricultural equipment, in particular to a spliced small arch shed frame.

### BACKGROUND

At present, the cultivation of flowers, fruits and vegetables has been more and more favored by modern people. The cultivation of flowers, fruits and vegetables can not only beautify one's courtyard and manor, but also let people rest assured to eat fresh pollution-free fruits and vegetables. However, under natural conditions, the cultivation cycle of flowers, fruits and vegetables is not only short, but also affected by many factors such as temperature, humidity, light, insects like birds. For this series of problems, it is common to build an arch shed frame and cover it with plastic film for insulation and moisture retention to extend the planting cycle; or cover it with a gauze net to prevent birds and insects; or cover it with a shading net to prevent strong light.

In the traditional construction of small arch shed, people often use bamboo poles or bamboo slices to build simple arch shed, thus the arch shed frame is perishable, short service life and low reuse rate. Most of the small arch shed frame bought from the market are fixed in shape, single shape structure, use environment is limited, and they can not adapt to local conditions; some also use the characteristics of fiberglass pole to build a small arch shed frame, the arch shed built in this way is not only unstable, but also the burr on the surface of fiberglass will stab the user.

In order to solve this series of problems, it is necessary to flexibly build the arch shed frame according to the actual environment and site layout, so that it can not only build a variety of styles of arch shed frames, but also can be stably covered with plastic film, gauze net, shading net and so on, and the cost is low.

### SUMMARY OF THE INVENTION

The object of the present invention is to solve the problems existing in the prior art and provide a spliced small arch shed frame. It can not only build a variety of styles of arch shed frames, but also can be stably covered with plastic film, gauze net, shading net and so on, and the cost is low.

The specific technical scheme of the present invention is as follows:

A spliced small arch shed frame comprises the arch pole, transverse connecting pole, longitudinal connecting pole, fixed pole, bi-directional clip and tri-directional clip; the bi-directional clip has at least two fixed ends, and the tri-directional clip has at least three fixed ends;

The arch pole, the transverse connecting pole, the longitudinal connecting pole and the fixed pole are all connected by a plurality of supporting hoops and a plurality of double-ended connectors, wherein the two ends of the double-ended connector are respectively connected with the ends of two adjacent supporting hoops; the supporting hoop is a toughness material;

Two transverse connecting poles and two longitudinal connecting poles are connected end to end together to form a rectangular base support structure, the two adjacent connecting poles in the base support structure are connected through two fixed ends of the tri-directional clip; a plurality of mutually parallel arch poles are arranged between the two transverse connecting poles; all arch poles are located above the base support structure and together constitute the arch support structure; the arch pole at both ends of the arch support structure is respectively connected with the end of the base support structure through the third fixed end of the tri-directional clip, the remaining arch poles are connected with the base support structure through the two fixed ends of the bi-directional clip; the fixed pole is set on the top of the arch support structure, and is connected with each arch pole in the arch support structure through two fixed ends of the bi-directional clip, so that all arch poles are connected as a whole.

Preferably, the supporting hoops are made of ductile plastic materials such as PE, PP and PVC.

Preferably, interference fit connection is adopted between the double-ended connector and the supporting hoop, the bi-directional clip and the supporting hoop, the tri-directional clip and the supporting hoop.

Preferably, the bi-directional clip comprises the upper fixing part and the lower fixing part which jointly constitute the cross structure and are fixedly connected to each other, the upper fixing part is the arc structure of the upper opening, and the lower fixing part is the arc structure of the lower opening; the openings of the upper fixing part and the lower fixing part can be connected with the outer wall of the supporting hoop by means of a snap connection.

Preferably, the tri-directional clip comprises a first fixing part, a second fixing part and a third fixing part which are fixedly connected with each other; the first fixing part, the second fixing part and the third fixing part are arc-shaped structures with different opening directions, and their openings can be connected with the outer wall of the supporting hoop by means of a snap connection.

Preferably, the double-ended connector is a structure with thin ends and thick middle, and its two ends are respectively inserted into the hollow inner cavity of two supporting hoops to connect the two supporting hoops.

Preferably, the surface of the double-ended connector is provided with barbs composed of a number of annular protrusions that increase friction.

Preferably, the bi-directional clip and/or the tri-directional clip shall be made of plastic.

Preferably, the ends of the exposed supporting hoop are provided with hoop plugs that can prevent puncture.

Preferably, a plurality of fixing poles are provided, which are respectively fixed at different positions of the arch support structure.

Compared with the prior art, the present invention has the following advantageous effects:

1) In the present invention, the ends of the exposed supporting hoop on the formed arch shed frame are closed with hoop plugs to prevent the exposed end from poking the user or piercing the covering.

2) The small arch shed frame of the present invention can be rapidly assembled and disassembled, and can be reused; at the same time, according to the different environment and site, as well as the different height of the plant, can build any shape, height, width of the arch shed frame.

3) The present invention can flexibly build the arch shed frame according to the actual environment and site layout, so that it can not only build a variety of styles of arch shed frames, but also can be stably covered with plastic film, gauze net, shading net and so on, and the cost is low.

### BRIEF DESCRIPTION OF THE DRAWINGS

FIG. 1 is a schematic diagram of the double-ended connector of the present invention;

FIG. 2 is a schematic diagram of the bi-directional clip of the present invention;

FIG. 3 is a schematic diagram of the connection mode between the double-ended connector and the supporting hoop of the present invention;

FIG. 4 is a schematic diagram of construction structure of the present invention;

FIG. 5 is a schematic diagram of construction structure of the arch pole bending directly inserted into the soil of the present invention;

FIG. 6 is a schematic diagram of the cross-sectional shape of the small arch shed: (a) arch, (b) ¼ circle, (c) square, (d) rectangle;

FIG. 7 is a schematic diagram of the upper fixing part and the lower fixing part;

Attached Drawings Marks: supporting hoop 1, double-ended connector 2, the bi-directional clip 3, the tri-directional clip 4.

### DESCRIPTION OF EMBODIMENTS

The present invention is further described below in combination with the drawings and specific embodiments. The technical features of each embodiment in the present invention can be combined accordingly on the premise of no conflict.

The present invention provides a spliced small arch shed frame, comprising the arch pole, transverse connecting pole, longitudinal connecting pole, fixed pole, bi-directional clip 3 and tri-directional clip 4. The bi-directional clip 3 has at least two fixed ends, and the tri-directional clip 4 has at least three fixed ends. The specific structure and connection mode of each component are as follows:

The arch pole, the transverse connecting pole, the longitudinal connecting pole and the fixed pole are all connected by a plurality of supporting hoops 1 and a plurality of double-ended connectors 2. As shown in FIG. 3, the two ends of the double-ended connector 2 are respectively connected with the ends of two adjacent supporting hoops 1; the arch pole, transverse connecting pole, longitudinal connecting pole and fixed pole can be arbitrarily spliced according to their desired length. The supporting hoop 1 adopts a toughness material, in this embodiment, the supporting hoop 1 can adopt PE hoop. PE hoop is a hollow straight hoop with good toughness, easy to bend, it is made of polyethylene plastic and has good toughness.

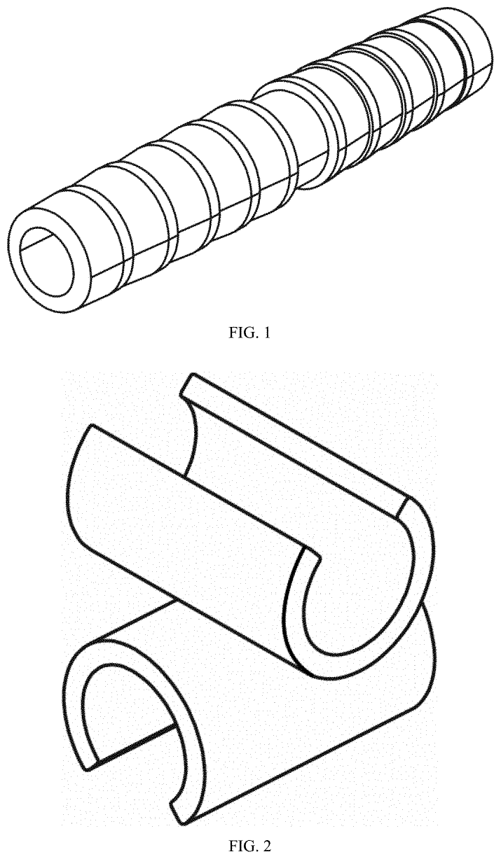

As shown in FIG. 1, the double-ended connector 2 is a structure with thin ends and thick middle, and its two ends are respectively inserted into the hollow inner cavity of two supporting hoops 1 to connect the two supporting hoops 1. In this embodiment, the surface of the double-ended connector 2 is provided with barbs composed of a number of annular protrusions that increase friction, so that interference fit connection is adopted between the double-ended connector 2 and the supporting hoop 1.

FIG. 4 is a schematic diagram of construction structure of the present invention, as follows:

the two transverse connecting poles and two longitudinal connecting poles are connected end to end together, that is, the transverse connecting pole and the longitudinal connecting pole are alternately connected end to end to form a rectangular base support structure. The length of the transverse connecting pole is longer than that of the longitudinal connecting pole. The two adjacent connecting poles in the base support structure are connected through two fixed ends of the tri-directional clip 4. A plurality of mutually parallel arch poles are arranged between the two transverse connecting poles, the two ends of the arch pole are respectively connected to two transverse connecting poles. In fact, the arch pole may be installed between two longitudinal connecting poles as required, and the two ends of the arch pole are respectively connected to two longitudinal connecting poles. All arch poles are located above the base support structure and together constitute the arch support structure. The arch pole at both ends of the arch support structure is respectively connected with the end of the base support structure through the third fixed end of the tri-directional clip 4, the remaining arch poles are connected with the base support structure through the two fixed ends of the bi-directional clip 3. The fixed pole is set on the top of the arch support structure, and is connected with each arch pole in the arch support structure through two fixed ends of the bi-directional clip 3, so that all arch poles are connected as a whole. In practical application, multiple fixed poles can be set, respectively fixed in different positions of the arch support structure to fix the position between the arch poles, increase the firmness of the arch shed, and prevent shaking.

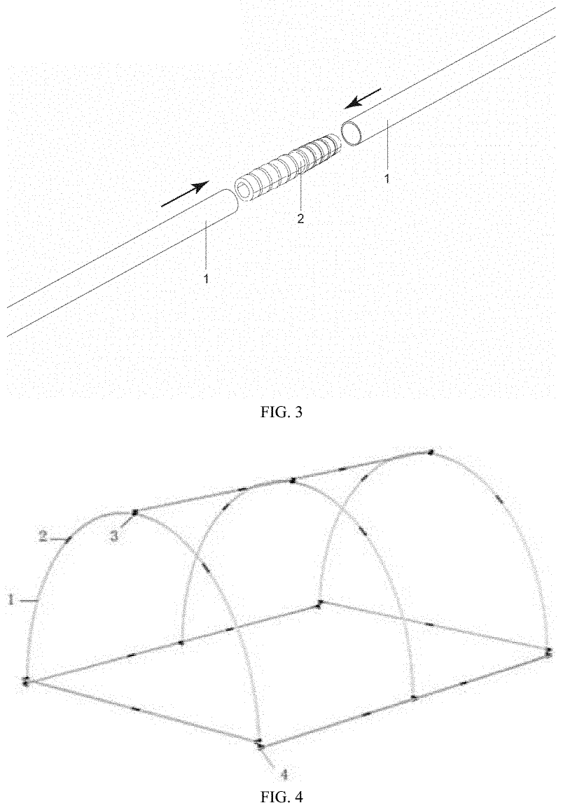

In this embodiment, as shown in FIG. 2, the bi-directional clip 3 comprises the upper fixing part and the lower fixing part which jointly constitute the cross structure and are fixedly connected to each other, the upper fixing part is the arc structure of the upper opening, and the lower fixing part is the arc structure of the lower opening; the openings of the upper fixing part and the lower fixing part can be connected with the outer wall of the supporting hoop by means of the snap and interference fit connection, as shown in FIG. 7, in fact, the fixed end connected between the bi-directional clip 3 and the supporting hoop 1 is not necessarily an arc structure, but also can adopt a cylindrical structure, square structure and other arbitrary shapes that can hold the supporting hoop 1 to make it connected and fixed.

The tri-directional clip 4 comprises a first fixing part, a second fixing part and a third fixing part which are fixedly connected with each other. The first fixing part, the second fixing part and the third fixing part are arc-shaped structures with different opening directions, the three together form a shape similar to a space coordinate system. The openings of the first fixing part, the second fixing part and the third fixing part can be connected with the outer wall of the supporting hoop by means of the snap and interference fit connection, so as to connect the arch pole, the transverse connecting pole and the longitudinal connecting pole as a whole. In fact, the fixed end connected between the tri-directional clip 4 and the supporting hoop 1 is not necessarily an arc structure, but also can adopt a cylindrical structure, square structure and other arbitrary shapes that can hold the supporting hoop 1 to make it connected and fixed.

In order to save cost, the bi-directional clip 3 and the tri-directional clip 4 can be made of plastic material, in the practical application, the parts connected by the tri-directional clip can also be replaced by multiple bi-directional clips as required.

In the practical application, the ends of the exposed supporting hoop 1 are provided with hoop plugs to prevent the exposed end from poking the user or piercing the covering. The hoop plug can be set as a smooth arc structure around the periphery, and the material can choose rubber and other materials.

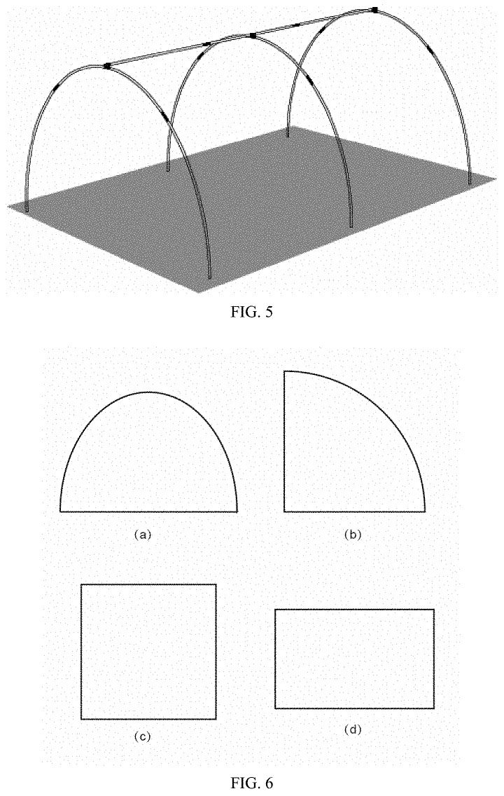

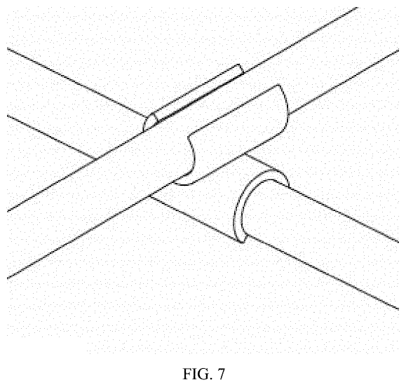

The small arch shed frame of the present invention can be rapidly assembled and disassembled, and can be reused. At the same time, according to the different environment and site, as well as the different height of the plant, the arch shed frame can also be built in any shape, height, width, as shown in FIG. 6, the cross section of the small arch shed frame can be constructed in arch, ¼ circle, square or rectangular and other arbitrary shapes.

In the practical application, the rectangular base consisting of the transverse connecting poles and longitudinal connecting poles can be removed, and the arch poles can be bent directly and inserted into the soil at both ends to make them fixed. Then a number of parallel arch poles are fixed by a number of fixed poles through the bi-directional clip 3.

The above embodiments are only a better scheme of the present invention, but they are not intended to limit the present invention. those having ordinary skills in the art may also make various changes and variations under the condition that they do not deviate from the spirit and scope of the present invention. Therefore, all technical solutions obtained by means of equivalent substitution or equivalent transformation fall within the protection scope of the present invention.

1. A spliced small arch shed frame comprises the arch pole, transverse connecting pole, longitudinal connecting pole, fixed pole, bi-directional clip (3) and tri-directional clip (4); the bi-directional clip (3) has at least two fixed ends, and the tri-directional clip (4) has at least three fixed ends;
The arch pole, the transverse connecting pole, the longitudinal connecting pole and the fixed pole are all connected by a plurality of supporting hoops (1) and a plurality of double-ended connectors (2), wherein the two ends of the double-ended connector (2) are respectively connected with the ends of two adjacent supporting hoops (1); the supporting hoop (1) is a toughness material;
Two transverse connecting poles and two longitudinal connecting poles are connected end to end together to form a rectangular base support structure, the two adjacent connecting poles in the base support structure are connected through two fixed ends of the tri-directional clip (4); a plurality of mutually parallel arch poles are arranged between the two transverse connecting poles; all arch poles are located above the base support structure and together constitute the arch support structure; the arch pole at both ends of the arch support structure is respectively connected with the end of the base support structure through the third fixed end of the tri-directional clip (4), the remaining arch poles are connected with the base support structure through the two fixed ends of the bi-directional clip (3); the fixed pole is set on the top of the arch support structure, and is connected with each arch pole in the arch support structure through two fixed ends of the bi-directional clip (3), so that all arch poles are connected as a whole.

2. A small arch shed frame according to claim 1, wherein the supporting hoops (1) are made of ductile plastic materials such as PE, PP and PVC.

3. A small arch shed frame according to claim 1, interference fit connection is adopted between the double-ended connector (2) and the supporting hoop (1), the bi-directional clip (3) and the supporting hoop (1), the tri-directional clip (4) and the supporting hoop (1).

4. A small arch shed frame according to claim 3, wherein the bi-directional clip (3) comprises the upper fixing part and the lower fixing part which jointly constitute the cross structure and are fixedly connected to each other, the upper fixing part is the arc structure of the upper opening, and the lower fixing part is the arc structure of the lower opening; the openings of the upper fixing part and the lower fixing part can be connected with the outer wall of the supporting hoop (1) by means of a snap connection.

5. A small arch shed frame according to claim 3, wherein the tri-directional clip (4) comprises a first fixing part, a second fixing part and a third fixing part which are fixedly connected with each other; the first fixing part, the second fixing part and the third fixing part are arc-shaped structures with different opening directions, and their openings can be connected with the outer wall of the supporting hoop (1) by means of a snap connection.

6. A small arch shed frame according to claim 1, wherein the double-ended connector (2) is a structure with thin ends and thick middle, and its two ends are respectively inserted into the hollow inner cavity of two supporting hoops (1) to connect the two supporting hoops (1).

7. A small arch shed frame according to claim 6, wherein the surface of the double-ended connector (2) is provided with barbs composed of a number of annular protrusions that increase friction.

8. A small arch shed frame according to claim 1, wherein the bi-directional clip (3) and/or the tri-directional clip (4) shall be made of plastic.

9. A small arch shed frame according to claim 1, wherein the ends of the exposed supporting hoop (1) are provided with hoop plugs that can prevent puncture.

10. A small arch shed frame according to claim 1, wherein a plurality of fixing poles are provided, which are respectively fixed at different positions of the arch support structure.
